(19) United States
(12) Patent Application Publication
(10) Pub. No.: US 2007/0234315 A1
(43) Pub. Date: Oct. 4, 2007

(54) Compiling an application by cluster members

(75) Inventors: Steven Joseph Branda, Rochester, MN (US); Matthew Ara Goshgarian, Rochester, MN (US); John Joseph Stecher, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/351,241

(22) Filed: Feb. 9, 2006

(51) Int. Cl. G06F 9/45

(52) U.S. Cl. 717/140

(57) ABSTRACT

In an embodiment, a source application is divided into source task subsets, which are sent to cluster members. A cluster member receives its source task subset, compiles it into a local compiled task subset, and sends the local compiled task subset to the other cluster members. The cluster member also receives compiled task subsets from other cluster members and combines them with its local compiled task subset into a compiled application. The cluster member also creates a local symbol data subset for its source task subset and sends the local symbol data subset to the other cluster members. The cluster member also receives symbol data subsets from other cluster members and combines them with its local symbol data subset into distributed symbol data. In this way, an application may be deployed to cluster members in parallel.

### FIELD

This invention generally relates to computer systems and more specifically relates to compiling an application by computer systems that are members of a cluster.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

One use of these more powerful computer systems is to implement application servers, which execute applications and provide services for security, data access, and persistence. Application servers are often distributed across a cluster in a network of multiple server computer systems, which may respond to requests from client computer systems. In order to respond to requests from many clients simultaneously, a cluster of servers may include large numbers of computer systems.

Applications are usually created in a development environment, such as with WSAD (Websphere Studio Application Developer). After the user has finished developing an application using the development environment, the application is then deployed to the various server computer systems that will execute the application. During deployment, a production environment is set up for the application on the servers. In the production environment, the application is executing on the servers and available to respond to requests from clients. Setting up the production environment includes compiling the application, installing the application at the servers, and configuring the application server to fit the needs of the specific application.

Users typically compile the application at one server, which is often the slowest computer system in the cluster, and then distribute the compiled application to the other servers. The slowest computer system is usually selected for the compilation because users want to continue to run their existing applications at optimal performance while the new application is being compiled. Further, the various components of the application are usually compiled serially, in turn. Thus, the compilation of the new application may be slow, which causes delay in deploying the application to the servers that are members of the cluster.

Thus, without a better way to deploy applications to clusters of servers, users will continue to experience delay.

### SUMMARY

A method, apparatus, system, and signal-bearing medium are provided. In an embodiment, a source application is divided into source task subsets, which are sent to cluster members. A cluster member receives its source task subset, compiles it into a local compiled task subset, and sends the local compiled task subset to the other cluster members. The cluster member also receives compiled task subsets from other cluster members and combines them with its local compiled task subset into a compiled application. The cluster member also creates a local symbol data subset for its source task subset and sends the local symbol data subset to the other cluster members. The cluster member also receives symbol data subsets from other cluster members and combines them with its local symbol data subset into distributed symbol data. In this way, an application may be deployed to cluster members in parallel.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example network of cluster members, according to an embodiment of the invention.

FIG. 3 depicts a flowchart of example processing for delivering source tasks to cluster members, according to an embodiment of the invention.

FIG. 4 depicts a flowchart of example processing for deploying applications to cluster members, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

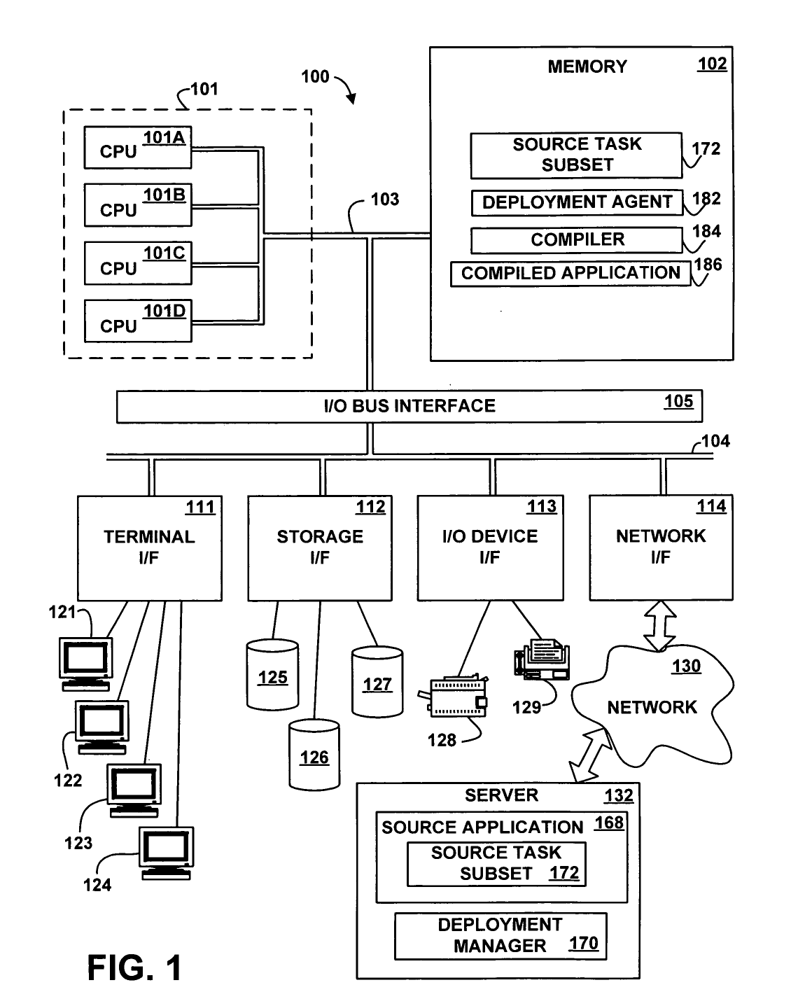

Referring to the Drawings, wherein like numbers denote like parts throughout the several views, FIG. 1 depicts a high-level block diagram representation of a cluster member computer system 100 connected via a network 130 to a server 132, according to an embodiment of the present invention. The terms “computer,” “server,” and “cluster member” are used for convenience only, and an electronic device that acts as a cluster member in one embodiment may act as a server in another embodiment, and vice versa. In an embodiment, the hardware components of the cluster member computer system 100 may be implemented by an eServer iSeries computer system available from International Business Machines of Armonk, N.Y. But, those skilled in the art will appreciate that the mechanisms and apparatus of embodiments of the present invention apply equally to any appropriate computing system.

The major components of the cluster member computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The cluster member computer system 100 contains one or more general-purpose programmable central processing units (CPUs) 101A, 101B, 101C, and 101D, herein generically referred to as the processor 101. In an embodiment, the cluster member computer system 100 contains multiple processors typical of a relatively large system; however, in another embodiment the cluster member computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the cluster member computer system 100, and may also include the virtual memory of other computer systems coupled to the cluster member computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a source task subset 172, a deployment agent 182, a compiler 184, and a compiled application 186. Although the source task subset 172, the deployment agent 182, the compiler 184, and the compiled application 186 are illustrated as being contained within the memory 102 in the cluster member computer system 100, in other embodiments some or all of them may be on different computer systems and may be accessed remotely, e.g., via the network 130. The cluster member computer system 100 may use virtual addressing mechanisms that allow the programs of the cluster member computer system 100 to behave as if they only have access to a large, single storage entity instead of access to multiple, smaller storage entities. Thus, while the source task subset 172, the deployment agent 182, the compiler 184, and the compiled application 186 are illustrated as being contained within the main memory 102, these elements are not necessarily all completely contained in the same storage device at the same time. Further, although the source task subset 172, the deployment agent 182, the compiler 184, and the compiled application 186 are illustrated as being separate entities, in other embodiments some of them, or portions of some of them, may be packaged together.

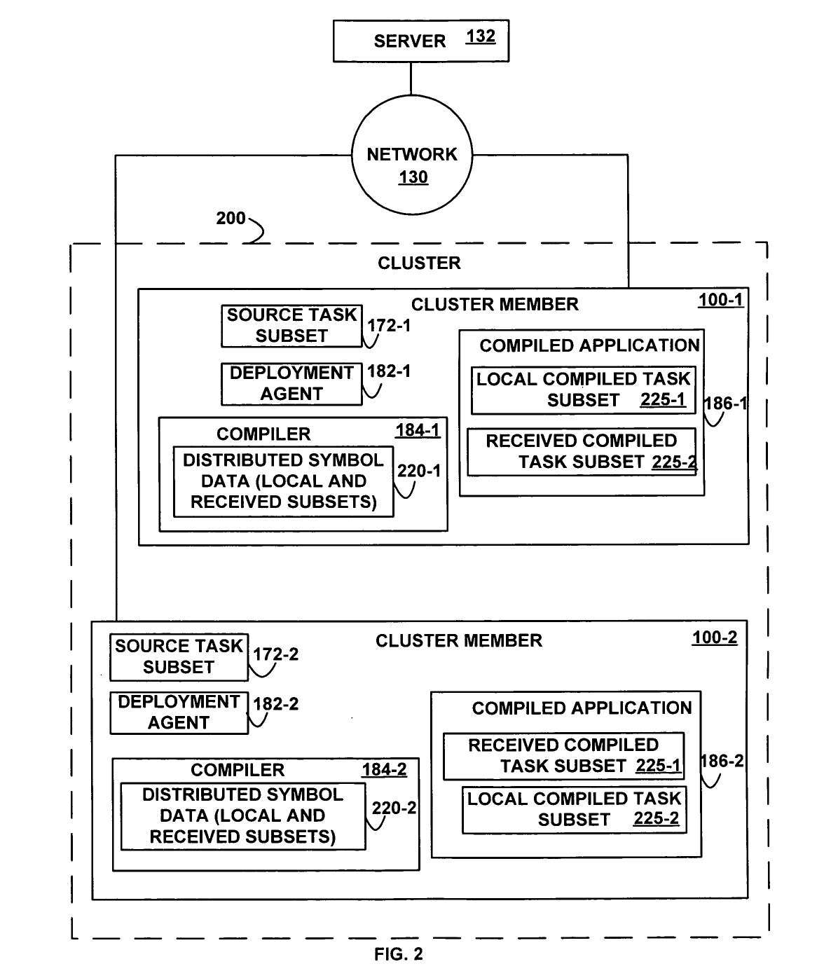

The deployment agent 182 receives the source task subsets 172 from the server 132 and sends the source task subsets 172 to the compiler 184. The compiler 184 creates local compiled task subsets, which the deployment agent 182 sends to other cluster members 100. The deployment agent 182 receives compiled task subsets from other cluster members 100 and combines them with the local compiled task subsets to create the compiled application 186. The source task subsets 172 include source code that is capable of being understood by a human. The compiled application 186 includes object code instructions, which are capable of executing on the processor 101. The cluster member computer systems 100 are further described below with reference to FIG. 2.

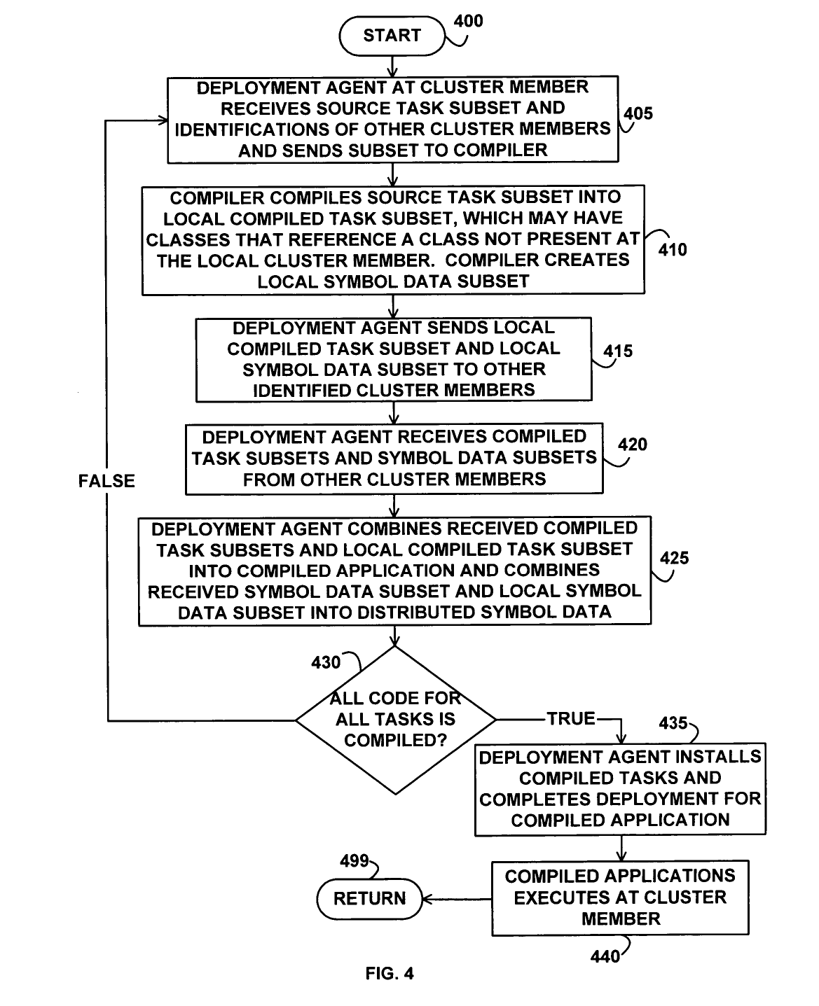

The deployment agent 182 and/or the compiler 184 include instructions capable of executing on the processor 101, or statements capable of being interpreted by instructions executing on the processor 101 to perform the functions as further described below with reference to FIG. 4. In another embodiment, the deployment agent 182 and/or the compiler 184 may be implemented in microcode or firmware. In another embodiment, the deployment agent 182 and/or the compiler 184 may be implemented in hardware via logic gates and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the cluster member computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the cluster member computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The cluster member computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The cluster member computer system 100 may alternatively be a single-user system, typically containing only a single user display and keyboard input, or might be a server or similar device which has little or no direct user interface, but receives requests from other computer systems (clients). In other embodiments, the cluster member computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the cluster member computer system 100. In various embodiments, the network 130 may represent a storage device or a combination of storage devices, either connected directly or indirectly to the cluster member computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server 132 may include some or all of the hardware and/or software elements previously described above for the cluster member computer system 100. The server 132 also includes a source application 168 and a deployment manager 170. The source application 168 is capable of being deployed to the cluster member computer systems 100 by the deployment manager 170. In an embodiment, the source application 168 may be an ear file (Enterprise Archive file) that represents a J2EE (Java 2 Enterprise Edition) application that can be deployed in a WebSphere application server, but in other embodiments any appropriate type of source application 168 may be used. Ear files are standard Java archive files (jar files) and have the same format. An ear file can consist of one or more web application modules, one or more EJB (Enterprise Java Beans) modules, one or more application client modules, additional jar files required by the application, and any combination thereof. The modules that make up ear files are themselves packaged in archive files specific to their types; for example, a web module contains web archive files and an EJB module contains Java archive files. Ear files also contain a deployment descriptor (e.g., an XML file any other type of descriptor) that describes the contents of the application and contains instructions for the entire application, such as security settings to be used in the run-time environment. The source application 168 may be any type of user application, a third-party application, an operating system, or any portion thereof.

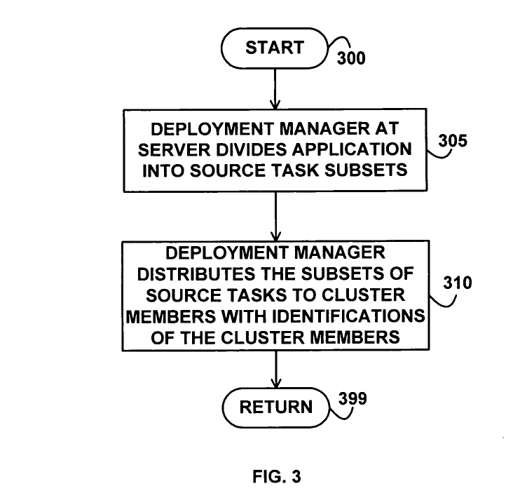

The deployment manager 170 creates any number of source task subsets 172 from the source application 168 and distributes the source task subsets 172 among the cluster members 100 for deployment. In various embodiments, the source application 168 may be divided into the source task subsets 172 on service or function boundaries, or on any other appropriate boundary. For example, a source task subset may include a web service or an Enterprise Java Bean (EJB). The deployment manager 170 includes instructions capable of executing on a processor analogous to the processor 101 or statements capable of being interpreted by instructions executing on the processor to perform the functions as further described below with reference to FIG. 3. In another embodiment, the deployment manager 170 may be implemented in microcode or firmware. In another embodiment, the deployment manager 170 may be implemented in hardware via logic gates and/or other appropriate hardware techniques in lieu of or in addition to a processor-based system.

It should be understood that FIG. 1 is intended to depict the representative major components of the cluster member computer system 100, the network 130, and the server 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the cluster member computer system 100 and/or the server 132, and that, when read and executed by one or more processors in the cluster member computer system 100 and/or the server 132, cause the cluster member computer system 100 and/or the server 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the cluster member computer system 100 and/or the server 132 via a variety of tangible signal-bearing media that may be operatively or communicatively connected (directly or indirectly) to the processor, such as the processor 101. The signal-bearing media may include, but are not limited to:

(1) information permanently stored on a non-rewriteable storage medium, e.g., a read-only memory storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmissions medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of example cluster 200 with example cluster member computer systems 100-1 and 100-2, the network 130, and the server 132, according to an embodiment of the invention. The cluster member computer system 100 (FIG. 1) generically refers to the cluster member computer systems 100-1 and 100-2.

The cluster member computer system 100-1 includes a source task subset 172-1, a deployment agent 182-1, a compiler 184-1, and a compiled application 186-1. The compiler 184-1 includes distributed symbol data 220-1, which includes a combination of a local symbol data subset and a received symbol data subset. The compiler 184-1 creates the local symbol data subset from compiling the source task subset 172-1 and receives the received symbol data subset from the other cluster members, e.g., the cluster member computer system 100-2. The compiled application 186-1 includes a combination of a local compiled task subset 225-1 and a received compiled task subset 225-2. The compiler 184-1 creates the local compiled task subset 225-1 by compiling the source task subset 172-1 and receives the received compiled task subset 225-1 from the other cluster members, e.g., the cluster member computer system 100-2.

The cluster member computer system 100-2 includes a source task subset 172-2, a deployment agent 182-2, a compiler 184-2, and a compiled application 186-2. The compiler 184-2 includes distributed symbol data 220-2, which includes a combination of a local symbol data subset and a received symbol data subset. The compiler 184-2 creates the local symbol data subset from compiling the source task subset 172-2 and receives the received symbol data subset from the other cluster members, e.g., the cluster member computer system 100-1. The compiled application 186-2 includes a combination of a local compiled task subset 225-2 and a received compiled task subset 225-1. The compiler 184-2 creates the local compiled task subset 225-2 by compiling the source task subset 172-2 and receives the received compiled task subset 225-2 from the other cluster members, e.g., the cluster member computer system 100-1.

Notice that the element 225-1 is named the “local compiled task subset” in the cluster member computer system 100-1, but the same element 225-1 is named the “received compiled task subset” in the cluster member computer system 100-2. Similarly, the element 225-2 is named the “local compiled task subset” in the cluster member computer system 100-2, but the same element 225-2 is named the “received compiled task subset” in the cluster member computer system 100-1. This is because the subset 225-1 is compiled locally at the cluster member computer system 100-1 and is sent to the other cluster members, such as the cluster member computer system 100-2, so the subset 225-1 is local from the point of view of the cluster member computer system 100-1, but is received from the point-of-view of the cluster member computer system 100-2. Likewise, the subset 225-2 is compiled locally at the cluster member computer system 100-2 and is sent to the cluster member computer system 100-1, so the subset 225-2 is local from the point-of-view of the cluster member computer system 100-2, but is received from the point-of-view of the cluster member computer system 100-1.

The deployment agent 182 (FIG. 1) generically refers to the deployment agents 182-1 and 182-2. The source task subset 172 (FIG. 1) generically refers to the source task subsets 172-1 and 172-2. The compiler 184 (FIG. 1) generically refers to the compilers 184-1 and 184-2. The compiled application 186 (FIG. 1) generically refers to the compiled applications 186-1 and 186-2.

FIG. 3 depicts a flowchart of example processing for delivering source tasks to the cluster member computer systems 100, according to an embodiment of the invention. Control begins at block 300. Control then continues to block 305 where the deployment manager 170 divides the source application 168 into the source task subsets 172, each of which includes less than the full content of the total source application 168. In various embodiments, the source application 168 may be divided into the source task subsets 172 on service or function boundaries, or on any other appropriate boundary. For example, a source task subset may include a web service or an Enterprise Java Bean (EJB).

Control then continues to block 310 where the deployment manager 170 distributes the source task subsets 172 to the cluster member computer systems 100 along with identifications of the cluster member computer systems 100, so that each cluster member computer system 100 receives identifications of the other cluster member computer systems 100. For example, if two cluster member computer systems 100 exist (e.g., the cluster member computer systems 100-1 and 100-2 of FIG. 2) the deployment manager 170 may divide the source application 168 into two source task subsets (e.g., the source task subset 172-1 and 172-2) and distribute the two source task subsets to the two cluster member computer systems (e.g., the source task subset 172-1 to the cluster member computer system 100-1 and the source task subset 172-2 to the cluster member computer system 100-2). Control then continues to block 399 where the logic of FIG. 3 returns.

FIG. 4 depicts a flowchart of example processing for deploying the applications 168 to the cluster member computer systems 100, according to an embodiment of the invention. Control begins at block 400.

Control then continues to block 405 where the deployment agent 182 at the cluster member computer system 100 receives a source task subset 172 of the source application 168 and identifications of the other cluster members 100 and sends the source task subset 172 to the compiler 184. For example, the deployment agent 182-1 receives its source task subset 172-1 and the deployment agent 182-2 receives its source task subset 172-2. Further, the deployment agent 182-1 at the cluster member computer system 100-1 receives an identification of the cluster member computer system 100-2, and the deployment agent 182-2 at the cluster member computer system 100-2 receives an identification of the cluster member computer system 100-1.

Control then continues to block 410 where the compiler 184 compiles the source task subset 172 into a local compiled task subset. The local compiled task subset may have a class or classes that reference a class or classes that are not present at the local cluster member 100. The compiler 184 further creates the local symbol data subset, which includes information regarding the variable names, method names, class names, object types, and other symbols used by the source task subset 172.

For example, the compiler 184-1 compiles the source task subset 172-1 into the local compiled task subset 225-1 and creates the local symbol data in the distributed symbol data 220-1, which includes information regarding the variable names, method names, class names, object types, and other symbols used by the source task subset 172-1. The local compiled task subset 225-1 may have a class or classes that reference a class or classes that are not present at the local cluster member 100-1 and instead are present at another cluster member, such as in the source task subset 172-2 at the cluster member computer system 100-2.

As another example, the compiler 184-2 compiles the source task subset 172-2 into the local compiled task subset 225-2 and creates the local symbol data in the distributed symbol data 220-2, which includes information regarding the variable names, method names, class names, object types, and other symbols used by the source task subset 172-2. The local compiled task subset 225-2 may have a class or classes that reference a class or classes that are not present at the local cluster member 100-2 and instead are present at another cluster member, such as in the source task subset 172-1 at the cluster member computer system 100-1.

Control then continues to block 415 where the deployment agent 182 sends its local compiled task subset and local symbol data subset to the other identified cluster members via the received identifications of the other cluster members. For example, the deployment agent 182-1 at the cluster member computer system 100-1 sends the local compiled task subset 225-1 and the local symbol data subset of the distributed symbol data 220-1 to the other cluster members, such as the cluster member computer system 100-2. As another example, the deployment agent 182-2 at the cluster member computer system 100-2 sends the local compiled task subset 225-2 and the local symbol data subset of the distributed symbol data 220-2 to the other cluster members, such as the cluster member computer system 100-1.

Control then continues to block 420 where the deployment agent 182 receives compiled task subsets and symbol data subsets from the other cluster members. The received compiled tasks were compiled from the subsets of the source tasks by the other cluster members. For example, the deployment agent 182-1 receives the received compiled task subset 225-2 and the received symbol data subset of the distributed symbol data 220-1 from the cluster member 100-2. As another example, the deployment agent 182-2 receives the received compiled task subset 225-2 and the received symbol data subset of the distributed symbol data 220-2 from the cluster member 100-1.

Control then continues to block 425 where the deployment agent 182 combines the received compiled task subset and the local compiled task subset into the compiled application 186 and combines the received symbol data subset and the local symbol data subset into the distributed symbol data. For example, the deployment agent 182-1 combines the received compiled task subset 225-2 and the local compiled task subset 225-1 into the compiled application 186-1 and combines the received symbol data subset and the local symbol data subset into the distributed symbol data 220-1. As another example, the deployment agent 182-2 combines the received compiled task subset 225-1 and the local compiled task subset 225-2 into the compiled application 186-2 and combines the received symbol data subset and the local symbol data subset into the distributed symbol data 220-2.

Control then continues to block 430 where the deployment agent 182 determines whether all code for all of the source task subsets 172 in the source application 168 has been compiled, either locally or compiled at other cluster members and received locally. If the determination at block 430 is true, then all code for all of the source task subsets 172 has been compiled, so control continues to block 435 where the deployment agent 182 installs the compiled task subsets, e.g., the compiled task subsets 225-1 and 225-2, and completes deployment of the compiled application 186. Control then continues to block 440 where the compiled application 186 executes at the cluster member computer system 100. Control then continues to block 499 where the logic of FIG. 4 returns.

If the determination at block 430 is false, then all code for all of the source task subsets 172 is not compiled, so control returns to block 405, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
receiving a first source task subset;
compiling the first source task subset into a local compiled task subset;
sending the local compiled task subset to at least one cluster member;
receiving at least one received compiled task subset from the at least one cluster member; and
combining the local compiled task subset and the at least one received compiled task subset into a compiled application.

2. The method of claim 1, wherein the first source task subset is one of a plurality of source task subsets, and wherein a source application is divided into the plurality of source task subsets.

3. The method of claim 2, wherein the at least one received compiled task subset was compiled from at least one of the plurality of source task subsets by the at least one cluster member.

4. The method of claim 1, further comprising:
receiving an identification of the at least one cluster member.

5. The method of claim 4, wherein the sending further comprises:
sending the local compiled task subset to the at least one cluster member via the identification.

6. The method of claim 1, wherein the compiling further comprises:
creating a local symbol data subset for the first source task subset.

7. The method of claim 6, further comprising:
sending the local symbol data subset to the at least one cluster member.

8. The method of claim 7, further comprising:
receiving a received symbol data subset from the at least one cluster member; and
combining the local symbol data subset and the received symbol data subset into distributed symbol data.

9. The method of claim 8, wherein the received symbol data subset was created from the at least one of the plurality of source task subsets by the at least one cluster member.

10. A signal-bearing medium encoded with instructions, wherein the instructions when executed comprise:
receiving a first source task subset, wherein the first source task subset is one of a plurality of source task subsets, and wherein a source application is divided into the plurality of source task subsets;
compiling the first source task subset into a local compiled task subset;
sending the local compiled task subset to at least one cluster member;
receiving at least one received compiled task subset from the at least one cluster member; and
combining the local compiled task subset and the at least one received compiled task subset into a compiled application.

11. The signal-bearing medium of claim 10, wherein the at least one received compiled task subset was compiled from at least one of the plurality of source task subsets by the at least one cluster member.

12. The signal-bearing medium of claim 10, wherein the compiling further comprises:
creating a local symbol data subset for the first source task subset.

13. The signal-bearing medium of claim 12, further comprising:
sending the local symbol data subset to the at least one cluster member.

14. The signal-bearing medium of claim 13, further comprising:
receiving a received symbol data subset from the at least one cluster member, wherein the received symbol data subset was created from the at least one of the plurality of source task subsets by the at least one cluster member; and
combining the local symbol data subset and the received symbol data subset into distributed symbol data.

15. A method for configuring a computer, comprising:
configuring the computer to receive a first source task subset, wherein the first source task subset is one of a plurality of source task subsets, and wherein a source application is divided into the plurality of source task subsets;
configuring the computer to compile the first source task subset into a local compiled task subset;
configuring the computer to send the local compiled task subset to at least one cluster member;
configuring the computer to receive at least one received compiled task subset from the at least one cluster member; and
configuring the computer to combine the local compiled task subset and the at least one received compiled task subset into a compiled application.

16. The method of claim 15, wherein the at least one received compiled task subset was compiled from at least one of the plurality of source task subsets by the at least one cluster member.

17. The method of claim 15, wherein the compiling further comprises:
configuring the computer to create a local symbol data subset for the first source task subset.

18. The method of claim 17, further comprising:
configuring the computer to send the local symbol data subset to the at least one cluster member.

19. The method of claim 18, further comprising:
configuring the computer to receive a received symbol data subset from the at least one cluster member, wherein the received symbol data subset was created from the at least one of the plurality of source task subsets by the at least one cluster member; and combining the local symbol data subset and the received symbol data subset into distributed symbol data.

20. The method of claim 15, further comprising:
configuring the computer to execute the compiled application.
